(19) United States
(12) Patent Application Publication
(10) Pub. No.: US 2009/0211473 A1
(43) Pub. Date: Aug. 27, 2009

(54) Printing press and method for register correction

(76) Inventors: Klaus Peters, Lohr am Main (DE); Leon Wei, Shanghai (CN)

Correspondence Address: MICHAEL J. STRIKER, 103 EAST NECK ROAD, HUNTINGTON, NY, 11743, US

(21) Appl. No.: 11/912,640

(22) PCT Filed: Apr. 27, 2006
(86) PCT No.: PCT/EP06/03932

§ 371 Date: Apr. 10, 2008

(30) Foreign Application Priority Data
Apr. 27, 2005 (DE) 10 2005 019 566.0

(51) Int. Cl. B41M 1/10; B41M 1/12

(52) U.S. Cl. 101/170; 101/150

(57) ABSTRACT

The invention relates to a drive device for a printing press (100), especially a shaftless printing machine by intaglio engraving, which comprises a plurality of individually driven printing groups (111 to 114) provided with linear register adjusting devices. The first printing group is provided with means for simultaneously adjusting the linear register adjusting devices of all printing groups (111; 111, 112; 111, 112, 113) mounted upstream of a first printing group (112; 113; 114) or with means for simultaneously adjusting the linear register adjusting devices of the first printing group (112; 113) and of all printing groups (113, 114; 114) mounted downstream of the first printing group (112; 113) in order to adjust a register variation (ΔR2, ΔR3, ΔR4) on the first printing group. The invention also relates to a method for adjusting a misalignment (ΔR2, ΔR3, ΔR4). According to said method, a material (101) is treated in subsequent treatment steps (110 to 115) and the misalignment (ΔR2, ΔR3, ΔR4) of the material is adjusted with respect to a first treatment step (111 to 115). The misalignment (ΔR2, ΔR3, ΔR4) is adjusted by changing the position of all treatment steps (110; 110, 111; 110, 111, 112; 110, 111, 112, 113; 110, 111, 112, 113, 114; 110, 111, 112, 113, 114, 115) upstream of the first treatment step (111; 112; 113; 114; 115) in the treatment sequence or by changing the position during the first treatment step (111; 112; 113; 114) and all treatment steps (112, 113, 114, 115; 113, 114, 115; 114, 115; 115) downstream of the first treatment step in the treatment sequence.

The invention relates to a drive system for a printing press as generically defined by the preamble to claim 1 and to a method for register correction or correction of an incorrect arrangement as generically defined by the preamble to claim 7.

### PRIOR ART

Rotary intaglio printing presses will essentially be referred to hereinafter, but the invention is not limited to that use.

In multicolor printing presses, a separate printing unit is available for each color. The material (paper, cardboard, fabric, and so forth) to be imprinted passes successively through the various printing units, and therefore the individual colored imprints must be applied exactly congruently.

In an intaglio printing press, a printing unit comprises, among other elements, a print cylinder to which the image to be printed is applied, and a counter-pressure cylinder (presser), which presses the paper against the print cylinder. In contrast to flexographic or offset printing presses, the counter-pressure cylinder is not driven.

The presser is positioned with high pressure against the material to be imprinted and the print cylinder, creating a unit connected by friction locking that can be moved or positioned only jointly. No relative motion between the material to be imprinted and the print cylinder is possible.

Longitudinal register deviations are eliminated by means of cylinder correction. The task of correction or register regulation is to compensate for incorrect arrangements and to assure that the printed image remains in register. To that end, a print cylinder is corrected by the amount of a suitable angular position. Because of the uniform connection between the printing unit and the material to be imprinted, the material to be imprinted is likewise displaced in slaved fashion. Thus initially, there is no change in the imprint on the material to be imprinted; instead, there is additional stretching or compression of the material as a result of the change in the web tension.

For instance, if a printing unit is corrected in such a way that the web is lengthened upstream of the printing unit and shortened after the printing unit, then the material is stretched upstream of the printing unit and relaxed downstream of the printing unit. The result is a difference in elongation. Only as a result of the constantly running transporting of the material is this difference in elongation and web tension rescinded and only then does the adjustment of the register to suit the corrected angular position become operative.

In addition, the change in web elongation in the region downstream of the corrected printing unit has an effect on the following printing units. The result is register deviations in the following printing units, and these are rescinded only slowly, although automatically and in an unregulated way. The length of time required for this is a multiple of the quotient of the web length and web speed. Material completed during this correction time is defective and cannot be used (spoilage).

This effect of a correction on downstream printing units moreover prevents the following printing units from being capable of being corrected separately during that time. Dynamic optimization of the register regulation is not possible.

The object therefore presents itself of speeding up the register correction and lessening the coupling among the individual printing units.

This object is attained by a printing press having the characteristics of claims 1 and 2 and by a method having the characteristics of claim 7.

Advantageous embodiments will become apparent from the various dependent claims and from the ensuing description.

### ADVANTAGES OF THE INVENTION

In a drive system according to the invention for a printing press, in particular a shaftless intaglio printing press, with a plurality of individually driven printing units that are provided with longitudinal register adjusters, means for common adjustment of the longitudinal register adjusters of all the printing units located upstream of a first printing unit, or means for common adjustment of the longitudinal register adjusters of the first printing unit and all the printing units located downstream of the first printing unit, are provided for correcting a register deviation at the first printing unit. By the common adjustment or actuation, the printing units are adjusted identically; that is, for all of them, the same correction of the angular position of the print cylinders is performed. It is understood that the invention equally includes the case where there is only one printing unit upstream or downstream of the affected first printing unit. As suitable means for implementation, essentially electric drives that individually and synchronously drive the components of the printing press by means of a virtual guide axis are suitable.

By the provisions according to the invention, the targeted influence on the web elongation as a result of the correction of the angular position becomes operative only in the region upstream of a first printing unit, where a register deviation exists, until the next fastening operation. This fastening is typically represented by a further printing unit. The change in the elongation can be accomplished by repositioning all the printing units upstream of the affected printing unit. It is equally possible to change the elongation upstream of the affected printing unit by correcting the affected printing unit itself as well as all the subsequent printing units. All in all, the elongation of material is changed only upstream of the affected first printing unit, without affecting the register and elongation of material in other portions. By means of the subsequent undoing of the change in material elongation, the register deviation is corrected.

In the drive system of the invention, means are typically also provided for adjusting a draw-in mechanism and/or a delivery mechanism. The register correction can accordingly be implemented both in the direction of the delivery mechanism and in the direction of the draw-in mechanism, or in both directions. Adjusting the draw-in mechanism and/or the delivery mechanism is advantageous for the decoupling, control, and maintenance of the web tension. Thus damage to the material to be imprinted, such as cracks, creases, and dog-earing and so forth can be avoided.

Advantageously, in an apparatus according to the invention, at least one longitudinal register adjuster for performing a cylinder correction is provided. The cylinder correction is a simple, reliable way of performing a register correction in which no additional mechanical or electrical devices, such as compensators, which must conventionally be located in the region of the web between two printing units to change the web length in this region, are necessary.

Expediently, an apparatus according to the invention has detection devices for detecting the register deviation, and each detection device is assigned to one printing unit. Depending on the procedure chosen (web/web or web/cylinder method), a detection device is located inside the web portion immediately upstream of the associated printing unit or downstream of the printing unit. If a detection device finds a register deviation, the associated printing unit is corrected in the manner described.

Two possible methods exist for detecting a register deviation: the web/web method and the web/cylinder method. It is expedient that an apparatus according to the invention is equipped with means for performing either the web/cylinder method or the web/web method. In the web/cylinder method, the position of a mark printed in the first printing unit is tracked. The printed mark detection devices or mark readers are typically seated upstream of the associated printing units. The position of the print cylinder is ascertained at the moment at which the printed mark moves past the mark reader. The cylinder position is compared with a predetermined set-point value. A difference ascertained corresponds to the register deviation. In the web/cylinder method, more-economical mark readers can advantageously be used and need not be embodied color-sensitively. In the web/web method, each printing unit applies its own marks in the applicable printing unit color on the material to be imprinted. The sensor or mark reader associated with a printing unit is therefore color-sensitive and is located along the web downstream of the associated printing unit. The spacing of the individual printed marks from one another is detected and compared with a set-point spacing value. A difference ascertained again corresponds to the register deviation.

In a method for register correction according to the invention in which a material is processed in successive processing steps, and the register deviation of the material is corrected with regard to a first processing step, the incorrect arrangement is corrected by means of a change of position within the scope of all the processing steps located before the first processing step or by a change of position during the first processing step and all the processing steps after the first processing step in the processing sequence. Thus the effect of the correction can advantageously be limited to the portion in question. This lessens the effect of the correction on other processing devices. It should be pointed out that the term “all processing steps” also includes a case in which there is only one processing step.

It is advantageous if the method is employed in conjunction with a printing press or paper processing machine, in particular a shaftless intaglio printing press. In that case, all the advantages discussed with regard to the printing press of the invention apply equally. In addition to its use for printing or paper processing methods, it can be used equally advantageously for any methods in which a material to be processed is processed with precise fit and successively in individual processing devices, such as printing presses for packages or job printing and narrow-web machines for labels and forms.

Typically, the processing steps are executed by means of printing units, draw-in mechanisms, and delivery mechanisms. In this embodiment, in particular the fit precision of the imprints and the web tension of the material to be imprinted can advantageously be varied.

A preferred application of the method of the invention is the correction of a longitudinal register deviation, in which the position change is executed at a cylinder correction in the form of a correction of the angular position of the cylinder. In this form, the method can be employed for rotary printing presses, for eliminating longitudinal register deviations.

Further advantages and embodiments of the invention will become apparent from the description and the accompanying drawings.

It is understood that the characteristics named above and to be further explained below can be used not only in the particular combination given but in other combinations as well or alone, without departing from the scope of the present invention.

### DESCRIPTION OF THE DRAWINGS

The invention and in particular its advantages will be described in further detail below in terms of an exemplary embodiment shown in the drawings.

FIG. 1 shows a schematic side view of one embodiment of an apparatus according to the invention; and

FIG. 2 shows a schematic illustration of a preferred embodiment of the method of the invention.

### DETAILED DESCRIPTION OF THE DRAWINGS

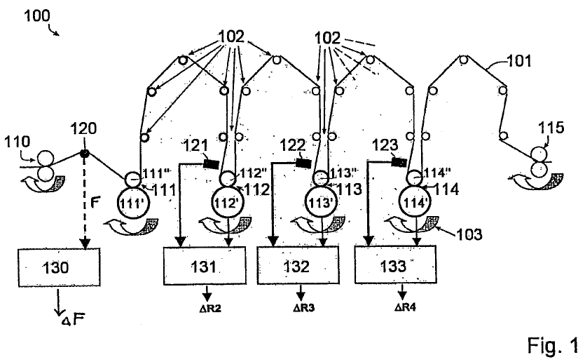

In FIG. 1, one preferred embodiment of the apparatus of the invention is identified overall by reference numeral 100. A material to be imprinted, such as paper 101, is fed into the machine via a draw-in mechanism 110. The paper 101 is guided by printing units 111, 112, 113, 114 and printed and is output again through a delivery mechanism 115. The draw-in mechanisms, delivery mechanisms and printing units 110 through 115 are positionable, and in particular are correctable in terms of cylinder and angle, as indicated by semicircular arrows 103. For the sake of simplicity, not all the arrows are identified by reference numerals.

The printing units 111 through 114 each have a respective print cylinder 111′ through 114′, against which a respective presser 111″ through 114″ is positioned with strong pressure. The print cylinders 111′ through 114′ are driven individually and independently; the pressers 111″ through 114″ are embodied freely rotatably. The draw-in mechanism 110 and delivery mechanism 115 each have two contrary-rotation cylinders that guide the paper 101. The draw-in mechanism 110 and delivery mechanism 115 and the printing units 111 through 114, together with the paper 101 passing through, each form a unit connected by friction locking.

In the web portions between the individual printing units 111 through 114, the paper 101 is guided via rollers and devices not explained in further detail and identified by reference numeral 102. For the sake of simplicity, not all the rollers and devices are identified by reference numeral 102. These may in particular be deflection rollers, drying devices, and so forth.

The web, between the draw-in mechanism 110 and the first printing unit 111, is provided with a sensor 120, which is embodied as a web tension sensor. Web tension values F detected by the sensor 120 are supplied to a measured value evaluation device 130. As a function of the web tension values F furnished by the sensor 120, the positioning of the draw-in mechanism 110 is controlled.

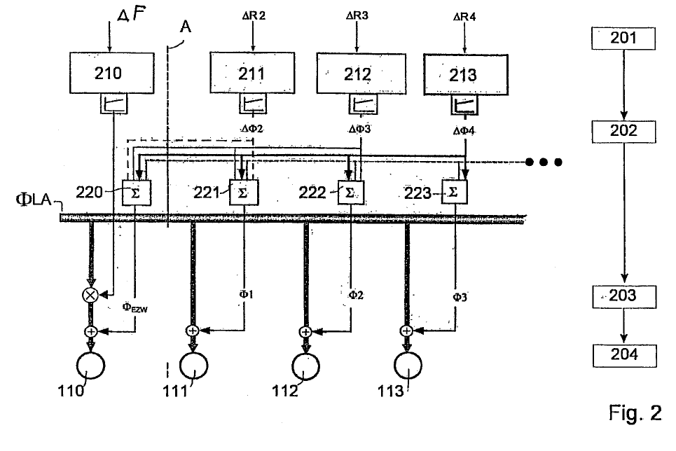

A sensor 121 is located in the portion of the web between the first printing unit 111 and the second printing unit 112; a sensor 122 is located in the portion of the web between the second printing unit 112 and the third printing unit 113; and a sensor 123 is located in the portion of the web between the third printing unit 113 and the fourth printing unit 114. The sensors 121 through 123 are embodied as mark readers. As the paper 101 passed through, a respective mark reader 121 through 123 detects when the printing mark (not shown), preferably applied by the first printing unit 111, reaches the mark reader and is delivered to a respective measured value evaluation device 131 through 133. Then the position of the corresponding print cylinder 112′ through 114′ is ascertained and likewise supplied to the respective measured value evaluation device 131 through 133. Each measured value evaluation device 131 through 133 compares the actual values for the cylinder position that have been supplied to it with predetermined set-point values and from that calculates a respective register deviation ΔR2 through ΔR4 (web/cylinder correction). The further processing of the registers ascertained will become clear by looking additionally at FIG. 2. The deviations are supplied to the arithmetic units 210, 211, 212, 213 and used for positioning the printing units 111 through 113 and optionally also for positioning the draw-in mechanism 110, as shown in detail in FIG. 2.

In FIG. 2, a preferred embodiment of the method of the invention is schematically shown. The vertical dividing line A represents a schematic subdivision of the method. The sequence to the right of the dividing line A represents the control and regulation of the printing units; the region to the left of the dividing line A represents the regulation of the draw-in mechanism. As already explained, the regulation of the draw-in mechanism is preferably additionally performed.

The preferred embodiment of the method of the invention is illustrated taking as an example the apparatus described in conjunction with FIG. 1, such that the incorrect arrangement or register deviation is corrected by means of a change in position of all the processing devices and printing units that in the processing sequence are located before the respective affected processing device or the affected printing unit. For one skilled in the art, it is understood how such a correction can be executed by a change in position of the respective affected processing devices and all the processing devices located in the processing sequence after the affected processing device.

In the first method step 201, the tension values F and register deviations ΔR2 through ΔR4, ascertained by the sensor 120 (FIG. 1) and the measured value evaluation devices 131 through 133 (FIG. 1), are supplied to the arithmetic units 210 through 213. It is understood that all the measured value evaluation devices 130 through 133 and arithmetic units 210 through 213 can be realized either centrally or decentrally (in the drive, motion control, SPS). From the register deviations ΔR2 through ΔR4, the arithmetic units 211 through 213 calculate the angle corrections ΔΦ2 through ΔΦ4 that are necessary for repositioning the respective print cylinder 111 through 113.

In method step 202, the ascertained angle corrections ΔΦ2 through ΔΦ4 are supplied to adder units 220 through 223. It is understood that analogously more than three register deviations may also be detected, as indicated by the dashed line and the three dots.

To correct the register deviation in the print cylinder 114 (FIG. 1), in the exemplary embodiment of the invention the angular position of the print cylinders 111 through 113 is changed. To that end, the angle correction ΔΦ4 calculated by the arithmetic unit 213 is supplied to all the preceding print cylinders by way of their adder units 221 through 223; in the preferred embodiment shown, this also means to the draw-in mechanism 110 by way of its adder unit 220. Analogously, for correcting the register deviation ΔR3 of the printing unit 113, the angle correction ΔΦ3 calculated by the arithmetic unit 212 is supplied to the adder units 220 through 222. The angle correction ΔΦ2 is finally supplied to the adder units 220 and 221.

The adder units 220 through 223 each calculate the total angle offset ΦEZW, Φ1 through Φ3 for a guide axis position that is represented by the symbol ΦLA. In method step 203, the respective angle offset values are calculated together with the value of the guide axis position and are forwarded to the corresponding draw-in mechanisms and printing units or their adjusting devices (not shown).

In method step 204, the draw-in mechanism 110 and the printing units 111 through 113 are repositioned in accordance with the calculated values, in order to correct the register deviations. By the method described, a register deviation for each printing unit can be corrected virtually simultaneously. In contrast to a correction in the prior art, in a printing press of the invention it is unnecessary to correct the register deviations individually and successively, since coupling among the printing units is reduced.

It is understood that in the drawings shown, only one particularly preferred embodiment of the printing press of the invention is shown. Any other embodiment, in particular by means of a different location or number of printing units, construction of the etc., is conceivable without departing from the scope of this invention.

### LIST OF REFERENCE NUMERALS

100 Printing press
101 Material to be imprinted (paper, film/foil, sheet metal)
102 Guide cylinders, guide rollers
103 Angle correction
110 Draw-in mechanism
111, 112, 113, 114 Printing unit
111′, 112′, 113′, 114′ Print cylinder
111″, 112″ 113″, 114″ Presser
111′″, 112′″, 113′″, 114′″ Drives
115 Delivery mechanism
120 Web tension sensor
121, 122, 123 Mark readers
130, 131, 132, 133 Measured value evaluation device
201, 202, 203, 204 Method step
210, 211, 212, 213 Arithmetic unit
220, 221, 222, 223 Adder unit
A Subdivision
F Web tension value
ΔF Web tension deviation
ΔR2, ΔR3, ΔR4 Register deviation
ΔΦ2, ΔΦ3, ΔΦ4 Angle correction
ΦEZW Angle offset
ΦLA Guide axis position

1. A drive system for a printing press (100), in particular a shaftless intaglio printing press, having a plurality of individually drivable printing units (111 through 114), which are provided with longitudinal register adjusters,
characterized by
means for the common adjustment of the longitudinal register adjusters of all printing units (111; 111, 112; 111, 112, 113) located upstream of a first printing unit (112, 113, 114), for correction of a register deviation (ΔR2, ΔR3, ΔR4) at the first printing unit.

2. A drive system for a printing press (100), in particular a shaftless intaglio printing press, having a plurality of individually drivable printing units (111 through 114), which are provided with longitudinal register adjusters,
characterized by
means for the common adjustment of the longitudinal register adjusters of the first printing unit (112; 113) and all the printing units (113, 114; 114) located downstream of the first printing unit (112; 113) for correction of a register deviation (ΔR2, ΔR3, ΔR4) at the first printing unit.

3. The drive system as defined by claim 1, characterized by means for adjusting a draw-in mechanism (110) and/or a delivery mechanism (115).

4. The drive system as defined by claim 1, characterized by at least one longitudinal register adjuster for performing a cylinder correction.

5. The drive system as defined by claim 1, characterized by detection devices (121, 122, 123) for detecting the register deviation (ΔR2, ΔR3, ΔR4), in which each detection device is assigned to one printing unit (112, 113, 114).

6. The drive system as defined by claim 1, characterized by means for performing a web/cylinder method or a web/web method for ascertaining a register deviation (ΔR2, ΔR3, ΔR4).

7. A method for correcting a register deviation (ΔR2, ΔR3, ΔR4), in which a material (101) is processed in successive processing steps (110 through 115), and the register deviation (ΔR2, ΔR3, ΔR4) of the material is corrected with regard to a first processing step (111 through 115),
characterized in that
the register deviation (ΔR2, ΔR3, ΔR4) is corrected by means of a change in position of all the processing steps (110; 110, 111; 110, 111, 112; 110, 111, 112, 113; 110, 111, 112, 113, 114; 110, 111, 112, 113, 114, 115) located prior to the first processing step (111; 112; 113; 114; 115) in the course of processing, or by means of a positioning during the first processing step (111; 112; 113; 114) and all the processing steps (112, 113, 114, 115; 113, 114, 115; 114, 115; 115)following the first processing step in the processing sequence.

8. The method as defined by claim 7 for use in conjunction with an intaglio printing press.

9. The method as defined by claim 8, characterized in that the processing steps are executed by means of printing units (111 through 114), draw-in mechanisms (110), and/or delivery mechanisms (115).

10. The method as defined by claim 9, characterized in that the register deviation is a longitudinal register deviation (ΔR2, ΔR3, ΔR4), and the position change is executed as a cylinder correction.
